(19) United States
(12) Patent Application Publication
(10) Pub. No.: US 2007/0127661 A1
(43) Pub. Date: Jun. 7, 2007

(54) Global directory registering telephony dialing information

(75) Inventor: Clifford Neil Didcock, Sammamish, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/294,928

(22) Filed: Dec. 6, 2005

(51) Int. Cl. H04M 3/00

(52) U.S. Cl. 379/198

(57) ABSTRACT

An enterprise-wide directory publishes a set of globally available and globally meaningful dialing information according to preset rules.

### BACKGROUND

This generally relates to systems and methods for managing telephony in a unified messaging environment.

Certain dialing plans used in telephone systems are expensive to configure and maintain. They require each piece of equipment to be configured with knowledge of each other piece of equipment with which they need to communicate. This is significant for creating and maintaining information to simplify the formation of dialing numbers.

Adding a new system requires that each of existing systems be configured to handle the new phone numbers of added system. In other words, whenever a new system is added, existing systems require point-to-point re-configuration between every end-point.

Such configurations increase the complexity of adding a new location to an enterprise. Similarly requiring precise user phone number configuration for all users (e.g., E164 numbers) is costly to maintain.

### SUMMARY

An enterprise-wide directory (e.g. a distributed directory) publishes a set of globally available and globally meaningful dialing information according to preset rules. This reduces the complexity of adding a new location to an enterprise to simply defining these dialing codes in the directory where they can be read by all other cooperating systems in the enterprise.

An enterprise manager is able to define in a fully distributed directory using dialing number formatting rules which are preset and which allow systems in the enterprise to reach any other. A globally replicated directory is a repository for dialing information and for differentiating the dialing information for in-country and international calling.

Other features will be in part apparent and in part pointed out hereinafter.

This summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one embodiment of an exemplary operating environment of the invention.

FIG. 2 is a diagram of one embodiment of a directory of the invention.

FIG. 3 is a flow diagram of one embodiment of the invention for using a directory.

Corresponding reference characters indicate corresponding parts throughout the drawings.

### DETAILED DESCRIPTION

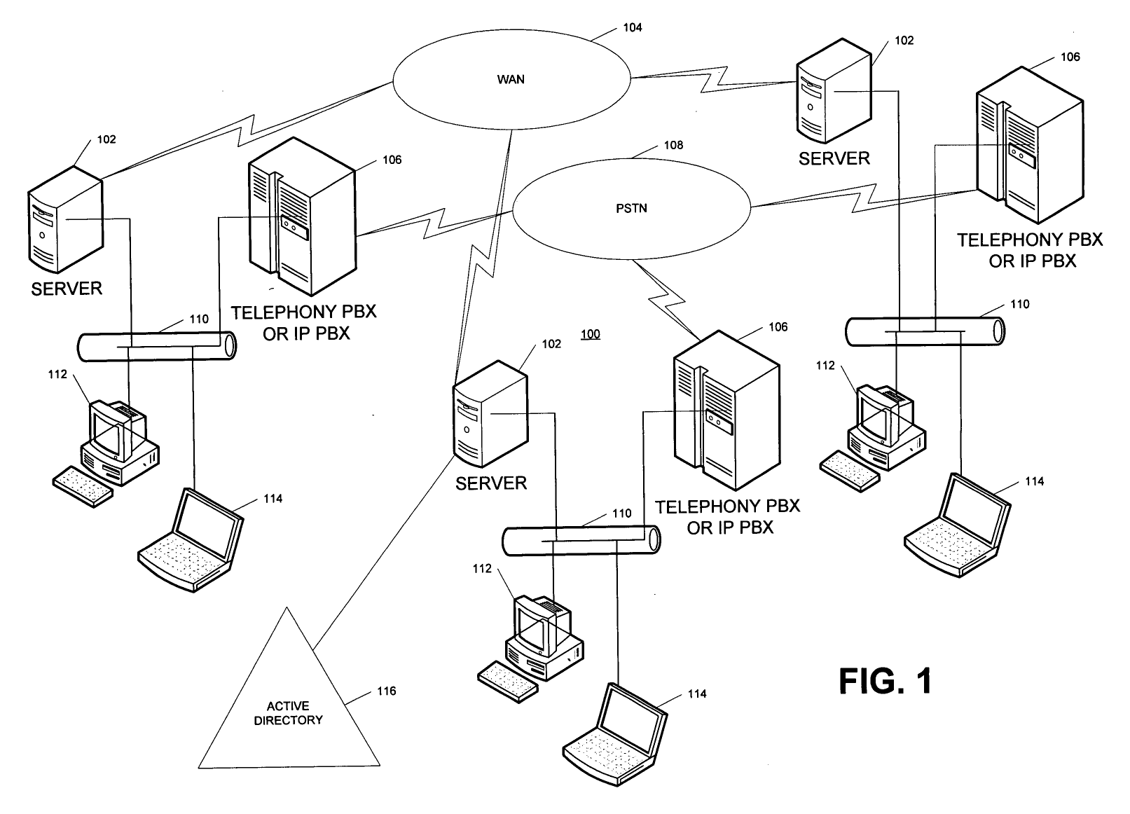

Referring to FIG. 1, an enterprise system 100 is illustrated including a plurality telecommunication equipment capable of launching calls. For example, the enterprise system 100 is an embodiment in which three networks are interconnected, each network having a telephony PBX (Private Branch Exchange) or an IP (Internet Provider) PBX capable of launching calls. In particular, each network in this example includes servers 102 interconnected by a wide area network (WAN) 104. Each server is running some form of computer telephony application. In addition, the enterprise system 100 includes a plurality of telephony PBX system or Internet PBX systems 106 interconnected by a public switched telephone network (PSTN) 108. Each PBX (Private Branch Exchange) system 106 is an automatic telephone switching system that enables users (not shown) within an organization to place calls to each other. Further, a network 110 interconnects at least one of the servers 102 and at least one of the switches 106. The network includes a plurality desktop computers 112 and laptop computers 114, either or both of which may be running a soft-phone application for launching calls on behalf of an end user. Exchange Unified Messaging System of Microsoft® is an example of server software that derives phone numbers for users retrieved from a directory, so that the number may be dialed automatically. It is contemplated that enterprise 100 may be any application that launches calls to people and retrieve their phone numbers automatically.

As illustrated in FIG. 1, the enterprise 100 includes two “clouds.” One is the PSTN 108 used to carry the actual phone calls once launched. The other is the WAN 104 providing a distributed directory capability, among other services. In one embodiment, directory information is presented via this WAN 104 so that all sites share a common view of the directory information. In particular, according to this embodiment, a distributed directory 116 is provided and maintained by one or more of the servers 102. The directory 116 is part of a platform that is designed to enable applications to find, use, and manage directory resources (for example, user names, network printers, and permissions) in a distributed computing environment. Distributed environments are usually heterogeneous collections of networks that often run proprietary directory services from different providers. To simplify directory-related activities associated with locating and administering network users and resources, the directory 116 presents applications with a single set of interfaces that eliminates the need to deal with differences between and among these proprietary services. In one embodiment, the directory 116 may be a component of the Windows® Open Services Architecture (WOSA). Alternatively, it is contemplated that the directory 116 may be a component of the PBX, or a external system accessible via the enterprise 100 or that the directory 116 may be maintained simultaneously at several locations.

According to one embodiment, each location of each system in the enterprise may be able to dial users located anywhere (locally, in country and internationally) in the enterprise. Since the directory 116 with associated processing logic according to one embodiment of the invention may be employed to manufacture a phone number that can be dialed from any location, it does not require a static configuration at each location.

Thus, FIG. 1 illustrates an embodiment of an enterprise system 100 comprising private branch exchanges 106 interconnected by the public switched telephone network 108 and servers 102 interconnected by the wide area network. Networks 110 interconnect the exchanges 106 and the servers 102 wherein the directory 116 is presented via the wide area network 104 and accessible via the exchanges 106 and the servers 102 to provide a common view of directory information of the system. Accordingly, the directory 116 includes resource information of dial plans of the plurality of exchanges 106 and the servers 102.

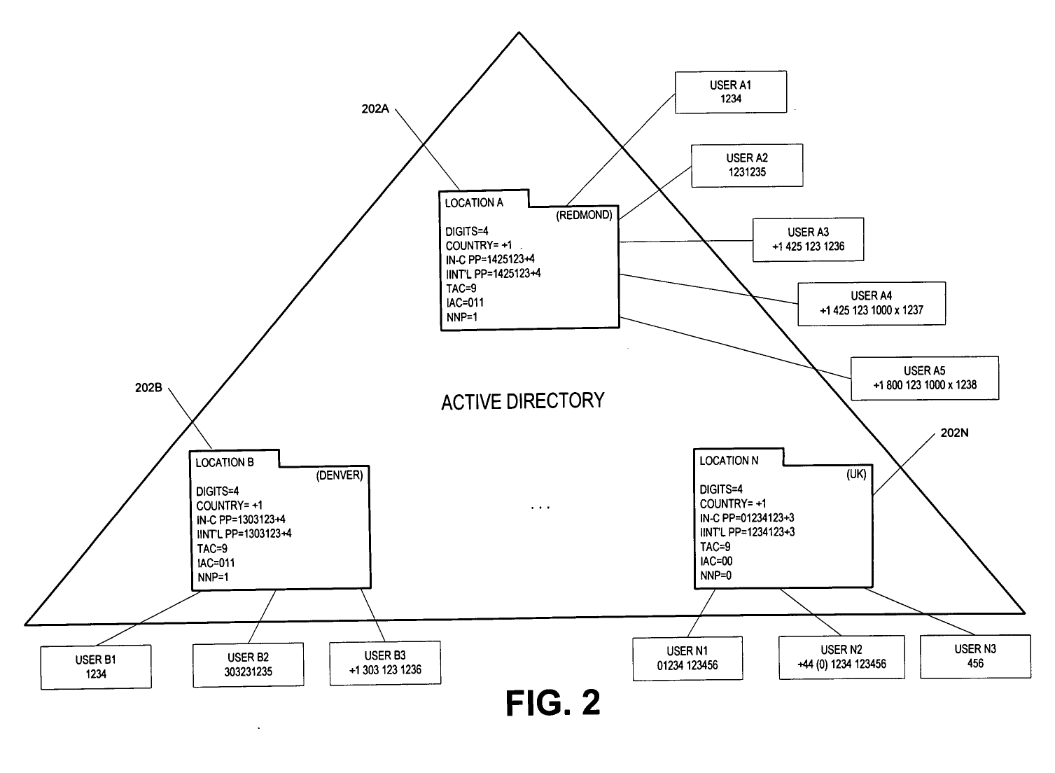

Referring to FIG. 2, according to one embodiment of the invention, the directory 116 stores a dialing format string for each dial plan 202A, 202B and 202C (collectively “202”). For example, the dial plan 202 may define dialing from any other location within the same country (e.g., from one domestic or in-country (IN-C) location to the defined dial plan location). Such an in-country dial plan may be defined for each set of users for whom a common, preset dialing rule can be defined. The number format string will specify the leading digits that need to be pre-pended to a user's extension number (found in the directory) to create a dial-able number from anywhere within the same country. As another example, the dial plan 202 may define dialing to one international (INT'L) location to any other location. Such an international dial plan may be configured to describe how to dial this location from any international location.

Each dial plan 202 for a particular location includes numbers or other information which indicates the dialing directions for the particular location. For example, dial plan 202A indicates the dialing directions to location A. DIGITS specifies the extension length of location A (e.g., the number of digits in an extension number). COUNTRY indicates the country code of the country in which location A is located. COUNTRY indicates the country code that a caller in a different country than location A would employ to call location A. IN-C PP indicates the in-country code phone prefix that a caller in the same country as location A would employ to call location A. INT'L PP indicates the international phone prefix that a caller in a different country than location A would employ to call location A. The configuration described above provides configuration information for people wanting to call into a location. The following configuration defines how a location may create dialable outbound numbers for dialing out. The dial plan defines how a location may create outbound dialable numbers (for dialing out) to the dial plan location. TAC is the trunk access code, IAC is the international access code and NNP is the national number prefix of location A.

In one embodiment, the dial plan 202 is a data structure comprising one or more of the following:
A first field defining a country code of the location (e.g., COUNTRY=; such as “1” for USA, 44 for UK);
A second field defining an in-country prefix for use by a calling location having a country code which is the same as the country code of the location specified in the first field (e.g., IN-C PP=);
A third field defining an international prefix for use by a calling location having a country code which is different than the country code of the location specified in the first field (e.g., INT'L PP=);
A fourth field defining an extension number for the location (e.g., DIGITS=);
A fifth field defining a trunk access code of the location (e.g., TAC=);
A sixth field defining an international access code of the location (e.g., IAC=); and
A seventh field defining a national number prefix of the location (e.g., NNP=).

As illustrated, the issue is that the phone number information stored on behalf of each user cannot be relied on to be in any particular format nor completeness. A user A1 is identified by their extension only. A user A2 is identified by their in-country phone number. A user A3 is identified by their international phone number. A user A4 is identified by their international phone number and extension. A user A5 is identified by their toll-free national phone number and extension. According to one embodiment of the invention, information in the dial plan of the directory 116 would be configured according to the same format so that any calling system could determine how to contact the user by accessing the dial plan of the directory 116.

In one embodiment, each of the servers 102 and each of the private branch exchanges 106 includes a processor executing instructions accessing one of the dial plans 202 of a destination to be contacted. The processor executes instructions deducing a dial-able phone number for dialing from the accessed dial plan 202. As noted herein, the dial-able phone number is based on a location accessing the dial plan and the location of the destination. A call to the destination may then be initiated using the deduced dial-able phone number.

### EXAMPLES

The following non-limiting examples are provided to further illustrate exemplary embodiments of the present invention.

The following are examples of format strings which would be available from the directory 116:

An In-Country-Format-String for a US Location:

142570XXXXX. Any other location within the US could call this site by using the number 142570 and adding a 5 digit personal extension number.
   An In-Country-Format-String for a London, UK Location:
0123576XXXX. Any location in the UK could call this site by dialing 0123576 and adding a 4 digit personal extension.
   An International-Format-String for a US location:
142570XXXXX. Any other location outside of the US could call this location using that countries international access code (e.g. 00) and the digits 142570 and a 5 digit extension.
   An International-Format-String for a UK Location:
44123576XXXX. Any location outside of the UK could call this location using that countries international access code (e.g. 011) and the digits 44123576 and a 4 digit extension.

If an administrator of a new site publishes to the directory 116 format strings such those above (e.g., an In-Country-String and an International-Format-String and a country code) then any other site in the enterprise will be able to manufacture dial-able numbers for people located at that site by accessing the directory 116. No remote-site administration will be required.

This can be elaborated further by returning to the previous example. Adding a new location means that this new location is configured once in the directory 116. No site-specific configuration is required at any other pre-existing locations. These locations will discover the new system by reference to a configuration container in the directory 116.

A number of application scenarios result in the need to launch an outbound call, including what number to dial and determining whether a user is authorized to launch a call to a number. These are separate but related issues.

Initially, the user selects the destination of a call by one or more of the following:
a) choosing them [by name] from an address directory (AD);
b) resolving a “from” email address against an AD or a personal contact list; and
c) calling a meeting organizer—resolving an email address against an AD.

One problem of deducing the precise number-to-dial starts with an unpredictably formatted phone number property derived from an AD property. Some AD deployments have well formed phone numbers—particularly for domestic employees. However, this may not always be the case so that this cannot be relied upon, in general. Frequently, customers tend to populate the phone number field according to local (if any) administrative policies.

Consider the following Table 1 of entries one might find in a directory phone number property and the actual number a UM (unified messaging) server based in the 425 area code in North America might successfully dial.

TABLE 1

| | Required Dial-able number |
|---|---|
| Directory Phone Number | (from within the 425 area |
| property | code) |
| +1 (425) 123 1234 x1234, or | 914251231234, or |
| +1 (425) 123 1234, or | 91231234, or |
| 425 123 1234, or | 1234 |
| 123 1234, or | |
| 1234 | |
| +1 (303) 123 1234 x1234, or | 913031231234 |
| 303 123 1234 | |
| 123 1234* | |
| +44 (0)1234 123456 x456, or | 9011441234123456 |
| +44 (0)1234 123456, or | |
| +44 01234 123456, or | |
| (01234) 123456*, or | |
| 123456*, or | |
| 456* | |

The entries in bold (*) do not, in themselves, contain enough information to be successfully dialed by a device in the 425 area code. It is believed that with suitable, preset dialing rules all of the others (not in bold) could be transposed into dial-able numbers. Further, with suitable global configuration, e.g., not per-user configuration, policies may be specified to allow the bold numbers to be dial-able.

According to one embodiment of the invention, the following additional properties are added to the dial plan object 202 of a user. For example, consider the following additional dial plan properties used to analyze and create dial-able numbers from directory phone numbers:
Country Code (e.g. 1 or 44 in the examples above)
In-country prepend digits+number of digits to take from the user phone number directory field. In the example properties above, the 303 dial plan might have “1303123” and 4 digits. In the +44 example, the administrator would enter “01234123” and 3 digits.
International prepend digits+number of digits to take from directory field. In the examples above the 303 dial plan would have 1303123 and 4 digits and the +44 dial plan would enter 441234123 and 3 digits.

These last two entries assume it is possible to create a valid dial-able number, for all subscribers of a dial plan, by taking a fixed digit string and appending a variable part from the user's phone number (e.g. an extension number).

Additional properties used by local UM servers (within the dial plan) to create dial-able numbers include the following:
Outside Line (Trunk) Access Code (e.g., TAC, 9 in the example above);
International Access Code (IAC, also known as an International Direct Dial (IDD) code, e.g., 011 in the US or 00 in Europe, in the example above);
National Number Prefix (e.g., NNP, 1 in the US, 0 in the UK).

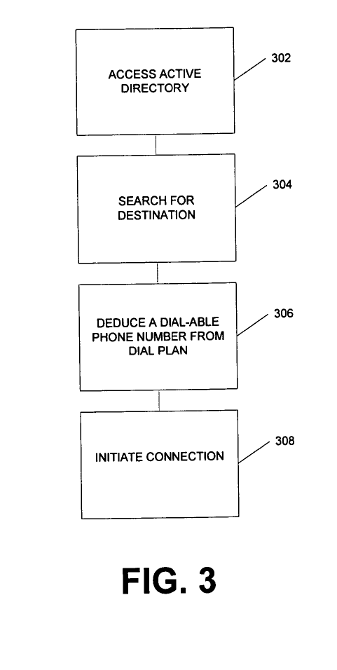

FIG. 3 illustrates one embodiment in which a calling location accesses a directory object of a destination location to be called in order to determine a phone number to initiate a call to establish a connection with a user at the destination location. At 302, the calling location accesses the directory 116 and at 304 searches for the destination to be called. At 306 the calling location finds the dial plan of the destination and accesses it to deduce a dial-able phone number. At 308, the deduced number is called to initiate the connection between the calling location and the destination user.

In summary, according to one embodiment of the invention as described above, a method is provided for telephonically communicating between a plurality of locations of systems having different access codes. For example, one of the locations (e.g., a caller) of servers 102 may want to call one of the locations (e.g., a destination) of exchanges 106. In this example, the server 102 (an originating system) would access the directory 116 specifying the dial plan 202 for the destination of exchange 106. The caller would deduce a dial-able phone number, as noted above, for dialing the exchange 106. As noted above, the dial-able phone number is based on the location of the caller and the location of the destination (e.g., same or different country. The server 102 initiates a connection to the destination via the exchange 106 using the deduced dial-able phone number.

The following is one embodiment of a set of hard-coded or preset rules to use the configuration information above to deduce a dial-able phone number for all entries. For the AD entries, the order described is believed to be a failsafe approach with reduced ways of calling, although other approaches are contemplated.

Deducing the Number to Dial—for AD entries—with Prepend Strings

If the user directory entry located contains a UMDialPlanID and the dial plan contains either International or In-Country prepend strings, then these strings should be used to create dialable numbers.

If the dial plan to be called has the same country code as the calling dial plan of the AD user, then:
NumberToDial=TAC+InCPP+InCPP-digits-from-phone-number.

Otherwise, if the dial plan to be called does not have the same country code as the calling dial plan of the user, then:
NumberToDial=TAC+IAC+IntPP+IntPP-digits-from-phone-number.
Number Restrictions

In one embodiment, it may be required that an administrator can restrict for whom a UM server will incur telephone calling charges. Restrictions are applied to two object classes—authenticated subscribers and unauthenticated callers. It will be a requirement for customers to be able to classify numbers into classes or groups, presumably with common billing implications, to allow number restrictions to be applied meaningfully.

There are some fixed number classes as well as the flexibility for an administrator to create classes of numbers defined for the purposes of controlling out-calling in UM.

In one embodiment, there may be one fixed number class—Extensions. There are two categories of admin-defined number classes:
In-Country Number Classes. The administrator can create zero or more number classes and numbers of the type InCountry will be matched against these number classes.
International Number Classes. The administrator can create zero or more international number classes.

A number class is given a name and an example might be Low-Rate calls. The number class is configured to contain a three column table such as illustrated in Table 2.

TABLE 2
In-Country Number Class - Name = ‘Low-Rate’

| Telephone Number | | |
|---|---|---|
| Mask | Dial String | Comment |
| 91425xxxxxxx | 9xxxxxxx | Local call |
| 9425xxxxxxx | 9xxxxxxx | Local call |
| 9xxxxxxx | 9xxxxxxx | Local call |
| 91206xxxxxxx | 91206xxxxxxx | Allow all 206 calls as |
| | | Low rate calls. |
| 9142570xxxxx | Xxxxx | We own all these DIDs |
| 942570xxxxx | Xxxxx | As above |
| 970xxxxx | Xxxxx | As above |
| 918xxxxxxxxx | 918xxxxxxxx | 800 numbers |

Another example is Table 3 for an In-Country Number class for long distance calls frequently required by employees to perform their jobs.

TABLE 3
In-Country Number Class - Name = ‘Business Use’

| Telephone Number | | |
|---|---|---|
| Mask | Dial String | Comment |
| 91408xxxxxxx | 91408xxxxxxx | Silicon Valley - |
| | | allow |
| 91415xxxxxxx | 91415xxxxxxx | Some other business |
| | | centre |
| 91303xxxxxxx | 91303xxxxxxx | Denver - major |
| | | customer location |

Similarly, certain users could be permitted to have open access to in-country numbers. This would be configured as shown in Table 4.

TABLE 4
In-Country Number Class - Name = ‘Any’

| Telephone Number | | |
|---|---|---|
| Mask | Dial String | Comment |
| 91* | 91* | Open access to in- |
| | | country numbers. |

Similarly, International numbers can be restricted through the creation and application of International Number Classes. Table 5 is an example.

TABLE 5
International Number Class - Name = ‘Countries we do
business with’

| Telephone Number | | |
|---|---|---|
| Mask | Dial String | Comment |
| 901144* | 901144* | UK - allow |
| 901133* | 901133* | France - allow |
| 901181* | 85581* | Route Japanese calls |
| | | through a private |
| | | network hub. |

These number classes are used to form an ‘allowed’ list of numbers. Numbers matching those in the first column may be dialed, and in order to do so, the dialing service software will use the number in the same row from the second column.

This last example shows a mapping between a public number and a private dial string. This allows administrators to configure out-dialing to use their leased line facilities.

Numbers will be matched within each table from top-to-bottom.

Application of Restrictions

Restrictions may be applied to UM subscriber policies as well as to unauthenticated callers. Dialing restrictions will be defined as a list of allowed number classes. Thus, the directory of a location includes number classes used to determine whether a caller is permitted to place calls to numbers derived from dial plan number format strings. This allows determining whether a caller is permitted to place calls to particular numbers as a function of the number classes. Thus, the data structure of the dial plan includes number classes which are applied to users and unauthenticated callers to control outbound calling. Consider the following examples:

A user policy called “Program Managers” could have a Dialing Restriction of: Extensions, Low-Rate and Business-Use. On the other hand, a user policy called “Managers” could have a Dialing Restriction of: Extensions, Low-Rate, Business-Use and Countries-we-do-business.

By contrast, an unauthenticated caller might only allow an Extension. Or, possibly, if customer connectivity is an important tool to the business, an Extension and Low-Rate.

Having described various embodiments of the invention in detail, it will be apparent that modifications and variations are possible without departing from the scope of the various embodiments of the invention as defined in the appended claims.

The order of execution or performance of the methods illustrated and described herein is not essential, unless otherwise specified. That is, it is contemplated by the inventors that elements of the methods may be performed in any order, unless otherwise specified, and that the methods may include more or less elements than those disclosed herein. For example, it is contemplated that executing or performing a particular element before, contemporaneously with, or after another element is within the scope of the various embodiments of the invention.

When introducing elements of the various embodiments of the present invention, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several advantageous results attained.

As various changes could be made in the above constructions, products, and methods without departing from the scope of the various embodiments of the invention, it is intended that all matter contained in the above description and shown in the accompanying drawings shall be interpreted as illustrative and not in a limiting sense.

What is claimed is:

1. In an enterprise system comprising:
One or more private branch exchanges connected to a public switched telephone network;
One or more servers interconnected by a wide area network; and
One or more networks interconnecting the exchanges and the servers; the improvement comprising:
A directory presented via the wide area network and accessible via the servers, said directory providing a common view of directory information of locations of the system.

2. The system of claim 1 wherein the directory comprises resource information of dial plans of locations accessible via the private branch exchanges and via the servers.

3. The system of claim 2 wherein each of the servers includes a processor executing instructions comprising:
Accessing the dial plan of a destination to be contacted;
Deducing from the accessed dial plan a dial-able phone number for dialing the destination users, wherein the dial-able phone number is based on a location accessing the dial plan and the location of the destination; and
Initiating a connection to the destination using the deduced dial-able phone number.

4. The system of claim 3 wherein the dial plan is a data structure comprising:
A first field defining a country code of the location;
A second field defining an in-country prefix for use by a calling location having a country code which is the same as the country code of the location specified in the first field;
A third field defining an international prefix for use by a calling location having a country code which is different than the country code of the location specified in the first field; and
A fourth field defining an extension length for the location.

5. The system of claim 4 wherein the data structure further comprises:
A fifth field defining a trunk access code of the location;
A sixth field defining an international access code of the location; and
A seventh field defining a national number prefix of the location.

6. The system of claim 1 wherein each of the servers includes a processor executing instructions comprising:
Accessing the dial plan of a destination user to be contacted;
Deducing a dial-able phone number for dialing from the accessed dial plan, wherein the dial-able phone number is based on a location accessing the dial plan and the location of the destination; and
Initiating a connection to the destination using the deduced dial-able phone number.

7. The system of claim 1 wherein the directory of a location includes number classes used to determine whether a caller is permitted to place calls to the location of the directory.

8. A method of telephonically communicating between a plurality of systems, each having a different access code, said method comprising:
Accessing by an originating system a directory specifying a dial plan for a destination user;
Deducing a dial-able phone number for dialing from the originating system to the destination system wherein the dial-able phone number is based on the location of the originating system and the location of the destination system;
Initiating by the originating system a connection to the destination system using the deduced dial-able phone number.

9. The method of claim 8 wherein the directory comprises resource information of dial plans of locations accessible via the servers.

10. The method of claim 9 wherein the directory of a location includes number classes, and wherein the method further comprises:
determining whether a caller is permitted to place calls to the location of the directory as a function of the number classes.

11. The method of claim 10 wherein each of the servers includes a processor executing instructions comprising:
Accessing the dial plan of a destination to be contacted;
Deducing a dial-able phone number for dialing from the accessed dial plan, wherein the dial-able phone number is based on a location accessing the dial plan and the location of the destination; and
Initiating a connection to the destination using the deduced dial-able phone number.

12. The method of claim 11 wherein the dial plan is a data structure comprising:
A first field defining a country code of the location;
A second field defining an in-country prefix for use by a calling location having a country code which is the same as the country code of the location specified in the first field;
A third field defining an international prefix for use by a calling location having a country code which is different than the country code of the location specified in the first field; and
A fourth field defining an extension length for the location.

13. The method of claim 12 wherein the data structure further comprises:
A fifth field defining a trunk access code of the location;
A sixth field defining an international access code of the location; and
A seventh field defining a national number prefix of the location.

14. The method of claim 8 wherein each of the servers includes a processor executing instructions comprising:
Accessing the dial plan of a destination to be contacted;
Deducing a dial-able phone number for dialing from the accessed dial plan, wherein the dial-able phone number is based on a location accessing the dial plan and the location of the destination; and
Initiating a connection to the destination using the deduced dial-able phone number.

15. A data structure for a dial plan of a location, said dial plan being part of a directory, said data structure comprising:
A first field defining a country code of the location;
A second field defining an in-country prefix for use by a calling location having a country code which is the same as the country code of the location specified in the first field;
A third field defining an international prefix for use by a calling location having a country code which is different than the country code of the location specified in the first field; and
A fourth field defining an extension length for the location.

16. The data structure of claim 15 further comprising:
A fifth field defining a trunk access code of the location;
A sixth field defining an international access code of the location; and
A seventh field defining a national number prefix of the location.

17. The data structure of claim 17 wherein the dial plan includes number classes which are applied to users and unauthenticated callers to control outbound calling.

18. The data structure of claim 15 wherein the directory includes number classes which are applied to users and unauthenticated callers to control outbound calling.
